(19) United States
(12) Patent Application Publication
(10) Pub. No.: US 2024/0111944 A1
(43) Pub. Date: Apr. 4, 2024

(54) System and Method for Annotation-Based Document Management

(71) Applicants: Gratiana Denisa Pol, Sherman Oaks, CA (US); Frederick L.C. Wedgeworth, III, Scottsdale, AZ (US)

(72) Inventors: Gratiana Denisa Pol, Sherman Oaks, CA (US); Frederick L.C. Wedgeworth, III, Scottsdale, AZ (US)

(21) Appl. No.: 18/240,495

(22) Filed: Aug. 31, 2023

Related U.S. Application Data
(60) Provisional application No. 63/403,252, filed on Sep. 1, 2022.

(51) Int. Cl. G06F 40/169; G06F 40/117

(52) U.S. Cl. CPC G06F 40/169; G06F 40/117

(57) ABSTRACT

This invention pertains to streamlining the process of annotating or extracting data content from a document or set of documents and generating a written report/review document about a specific source document or set of documents, whereby the report contains content generated by one or multiple users. The invention describes an annotation-based document management system that includes at least three interrelated regions of a graphical user interface and enables users to quickly access, from a list of documents, locations of interest within each document. Additionally, the invention automatically converts one's annotation/notes pertaining to a source document/set of documents into a compiled report/review document, with relevant location references linked to the source document/set of documents. The enables a faster transition from annotation/notes to a final document, ensures accurate location referencing, and simplifies the process of checking the content of the report/review document against the relevant locations in the source document/set of documents.

### CROSS-REFERENCE TO RELATED APPLICATIONS

This U.S. non-provisional application claims the benefit of U.S. provisional application No. 63/403,252, filed on Sep. 1, 2022, the contents of which are expressly incorporated by reference herein.

### STATEMENT REGARDING FEDERALLY SPONSORED RESEARCH OR DEVELOPMENT

This invention was not made with Government support.

### BACKGROUND

### Technical Field

This disclosure relates generally to the field of annotating or extracting data content from a document or set of documents, and organizing the set of documents into a system, particularly when the extracted or annotated data needs to be stored, retrieved, or searched according to a pre-defined structure. The invention is particularly useful for cases in which the data to be extracted/annotated (a) needs to be stored according to a structured template, (b) has a complex, hierarchical structure, or (c) is part of a large document set. This disclosure also relates generally to the field of generating a written report/review document about a specific source document or set of documents, whereby the report contains content generated by one or multiple users.

### Definitions

“Document” means any structured or unstructured data set, across a variety of data formats
“Element of a document” means any textual, graphical, or media component that is part of a document
“Region of a graphical user interface” means a visually delineated region of a graphical user interface, such as a pane or window. For the purpose of this disclosure, the words “region” and
“pane” are being used as a synonym for “region of a graphical user interface,” to facilitate readability.
“Data extraction” means identifying within a document at least one content element (e.g., a text fragment, table column, graphic, etc.) that is deemed a good fit for at least one data field, and recording that content element as a value for that data field
“Data” generally refers to specific entities such as variables, effects, scientific claims, elements of a legal case, traditional entities (people, places, things), etc. This tasks typically, although not always, involves systematically going through an extraction form/template and identifying, for each extraction field, the relevant entities in the document text that fit the criterion for that field. This task can, in principle, be fully automated, because it relies on a comparison between document text and a criterion
“Data annotation” refers to identifying a relevant content element within a document and recording an annotation (e.g., a comment or explanation) pertaining to that content element. This tasks typically, although not always, involves going through the document text and identifying relevant document text fragments that can be used for evaluating the document, either positively or negatively, along one or more criteria. This task cannot be fully annotated, because it relies on the expertise of a human annotator, often a subject matter expert (SME) of the content in the document(s)
“Table of Documents Region” and “Region 1” refer to a visual representation of the available documents in the corpus (e.g., assigned to a project). This region is interconnected with the other regions identified. It can provide an interactive visualization of the metadata, statistics, state of the documents in the corpus and, most relevantly, a concise representation of the identified content for each document.
“Document Content Region” and “Region 2” refer to a visual representation of the content of a document being worked on (e.g., extracted/annotated). This region is interconnected with the other regions identified. It provides a method for a user to select (identify) content data within a document to extract/annotate as well as view previously identified content within the context of all the document's content.
“Extraction/Annotation Region” and “Region 3” refer to a visual representation of the extracted/annotated data. This region is interconnected with the other regions identified. It is designed for displaying structured information, such as one or more forms, tables, or graphs, and may provide a method for a user to interact with and edit extracted and annotated data.
“Content markup” or “content mark-up” refer to the visual enhancement of an element of a document, whereby that element is made to appear more visible or prominent, for example through the addition of a highlight, a border, a different text or background color, etc.
“Report/review document” refers to a document containing organized, user-generated information about a source document or set of documents, whereby this information is written for a specific audience, typically with the goal of being shared with that audience.
“Source Document Content Region” refer to a visual representation of the content of a source document being worked on (e.g., extracted/annotated), shown in a region of a graphical user interface, such as a window or pane. This region is interconnected with the other regions identified. It provides a method for a user to select (identify) content data within a document to extract/annotate as well as view previously identified content within the context of all the document's content.
“Annotation/Note-taking Region” refers to a visual representation of the extracted/annotated data, shown in a region of a graphical user interface, such as a window or pane, distinct from other regions. This region is structured either as an extraction template or as a series of annotation/comment boxes, and typically has the appearance of a form with entries. The region is interconnected with the other regions described in this disclosure. It provides a method for a user to interact with and edit extracted and annotated data.
“Report/Review Region” refers to the visual representation of the information contained in the Annotation/Note-Taking Pane, compiled into a single, continuous document that has the appearance of a text- or HTML-based report/review document, and shown in a region of a graphical user interface, such as a window or pane, distinct from other regions. It provides a method for a user to review, interact with, and edit the extracted and annotated data, so as to ultimately produce a human reader-friendly report/review that can be shared with the intended audience.

### Background Art Description

It is assumed that a standard data extraction/annotation process for a set of documents involves, at a minimum, three steps: (1) identifying, inside a document, at least one content element that one wishes to extract or annotate, (2) (For data extraction) assigning the identified document content element to at least one data field; (for data annotation) creating at least one annotation, in at least one annotation category, for the identified content element as indicated below, and (3) accessing and reviewing the extracted/annotated data, which can be done within or across documents.

Additionally, it is assumed that the standard process of generating a written report/review document that references content from more other documents entails the following steps: (1) identification (i.e., identifying, inside a source document/set of documents, at least one content element that one wishes to make an annotation/note about), (2) annotation/note-taking (i.e., creating at least one annotation/note, in at least one annotation/note category, for each identified content element in the source document/set of documents. Such annotation/notes can be created in two locations: (a) inside the source document, typically to the right of the document text, next to the location of the relevant content (an example of this are comments that users can generate in Word or Google Docs), or (b) inside a separate document, which serves as the report/review document, (3) compilation (i.e., if the annotations/notes are generated inside the source document, then this step involves copying, across the source document/set of documents, all the relevant annotated data/notes, and compiling this information into a report/review document. It may also involve organizing this compiled information, and, if needed, editing it), and (4) location references (i.e., this step, which may be performed in parallel with step 3, involves including in the final report/review document information that enables the intended audience to check the content of the report/review document against the content of the source document that was reviewed/reported on. This is typically done by specifying, for at least one statement, which particular location(s) in the source document (such as page numbers, paragraph numbers, section names or numbers, etc.) that statement refers to).

The present disclosure makes it faster and more convenient to perform one or more of the steps described above, either for data extraction/annotation process of a set of documents, or for generating a written report/review document that references content from more other documents. It does so largely by establishing relationships (‘linkages’) between the different elements generated during data extraction/annotation/note-taking task, as described below:

The invention makes the identification step faster via a user feedback loop, which involves the system using a computer-enabled method to identify and then automatically pre-tag relevant content elements in a document, using interactive visual markups. When a user accepts or rejects an individual pre-tagged content element, this information gets fed back to the system as part of an “active learning” pipeline, thus helping to continuously improve the system's predictive performance.

The invention makes the classification step faster by utilizing two side-by-side regions of a graphical user interface—a Document Content Region and an Extraction/Annotation region—that are interlinked, such that an operation performed in one region triggers a subsequent, classification-supporting operation in the other region. This includes the following:

If the classification involves assigning the identified content element to a field or category that corresponds to a section of the document, then, when a user selects or markups a content element located in a specific document section, the system automatically opens or activates the corresponding field or category in the Extraction/Annotation Region, and assigns the text markup to that section.

If the classification involves extracting and creating a list of data values from a document, the system automatically appends each additional identified content element to a list, generates an ID for it, and displays the updated list in the Extraction/Annotation Region.

If an already classified content element needs to be re-classified to a different category, it can be manually dragged to its corresponding category in the Extraction/Annotation Region; if that category is associated with a particular visual indicator (for example, a specific color), the visual indicator gets automatically updated in both regions.

The invention makes accessing and reviewing the extracted/annotated data faster, which can be done at two levels:

Within a document, the invention utilizes mirror linkages between the Document Content Region and Extraction/Annotation Region, whereby (a) the same element in the Extraction/Annotation region can be linked to several markups in the Document Content Region, and a location indicator gets created in the Extraction/Annotation Region for each markup, and (b) performing an action on a content markup or annotation/extracted data in a region (for example, clicking on it or deleting it) results in the same/equivalent action being applied to the corresponding element in the other region.

Across documents, the invention utilizes a system of three interlinked regions of a graphical user interface (Document Content Region, Extraction/Annotation Region, and Table of Documents Region) and allows for a full information exchange loop to be completed among them, using hyperlinked data elements.

Synergies exist between the elements described above, making the data extraction/annotation process significantly more efficient when specific element combinations are present. The invention is applicable to cases when each step in the data extraction/annotation process is conducted manually, or when one or more steps are performed by a machine algorithm.

Additionally, the invention benefits the written report/review document generation process. Issues with the typical written report/review document generation process include the following:

If the annotation/notes are created inside the source document, typically to the right of the document text (which makes it easy to write annotation/notes while reading or inspecting the document), then, after all the annotation/notes have been created, this method places on the user the onus to copy each (relevant) comment, compile them into a separate document, and add location references when relevant. Such a method is inefficient and can lead to errors when referencing the locations in the source document.

If the annotation/notes are created inside a separate document, which serves as the report/review document, the user has to work with two different documents side-by-side (i.e., the source document and the report/review document). If the two documents are accessed via different software (e.g., PDF vs. Word), switching back-and-forth between the two documents can be tedious for the user and can lead to errors when referencing the locations in the source document.

The invention provides the following benefits the make the written report/review document generation process more efficient:

(For the report/review document creator): simplifies the process of converting one's annotation/notes pertaining to a source document/set of documents into a compiled report/review document, with relevant location references, and ensures accurate location referencing.

(For the report/review document audience): simplifies the process of checking the content of the report/review document against the relevant locations in the source document.

### DESCRIPTION OF THE DRAWINGS

FIG. 1 is an illustration of the System of Three Interlinked Regions of a Graphical User Interface;

FIG. 2A is an illustration of Linkages between Regions 2 and 3, for single-value data extraction fields;

FIG. 2B is an illustration of Linkages between Regions 2 and 3, for multiple-values data extraction fields;

FIG. 2C is an illustration of Linkages between Regions 2 and 3, for annotation fields with location markers;

FIG. 3A is an illustration of Ways of Organizing and Displaying Data in Region 2, with Region 2 with single-text entry field;

FIG. 3B is an illustration of Ways of Organizing and Displaying Data in Region 2, with Region 2 with multiple-text entry field;

FIG. 3C is an illustration of Ways of Organizing and Displaying Data in Region 2, with Region 2 with different types of text entry fields;

FIG. 3D is an illustration of Ways of Organizing and Displaying Data in Region 2, with Region 2 with different types of text entry fields and data categories;

FIG. 3E is an illustration of Ways of Organizing and Displaying Data in Region 2, with Region 2 with multiple-text entry field and dedicated section for displaying a list of values;

FIG. 4A is an illustration of Interactivity and Interlinking between Region 2 and Region 3 Elements with no content markup selected in Region 2

FIG. 4B is an illustration of Interactivity and Interlinking between Region 2 and Region 3 Elements with content markup selected in Region 2

FIG. 5A is an illustration of the Annotation/Note-Tagging View, with linkages shown between the two regions;

FIG. 5B is an illustration of the Review/Report View, with linkages shown between the two regions;

FIG. 5C is an illustration of the Multiple Review/Report View, for multiple annotators/reviewers; and

FIG. 5D is an illustration of the Multiple Review/Report View, for multiple documents.

### DETAILED DISCLOSURE

For a Document Set: System of Three Interlinked Panes/Windows (that allows for at least one full data loop among the panes)

The data extraction/annotation and organization system for a set of documents includes at least three interlinked regions/windows:

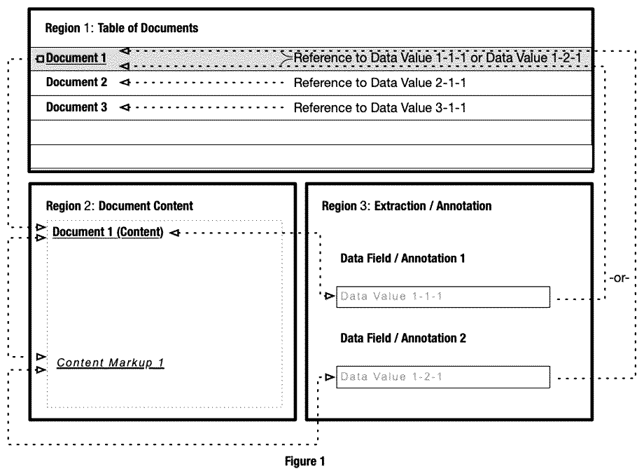

A region/window for listing one or more documents in a tabular format (“Region 1: Table of Documents”), whereby each document listing contains at least one document identifier (e.g., a document name or ID) and one data value/annotation associated with that document (associated either with the document as a whole or a section of the document). To illustrate, in FIG. 1, the document identifiers are shown in column 1, as Document 1, Document 2, etc. The data in Region 1 can be additionally linked to a graphical interface that provides a visualization for some or all the data values present in Region 1. The data value/annotation associated with that document can be the exact value displayed in Region 3, or a reference to that data value (for example, a description or indicator of that data value). Each document listing may be accompanied by additional textual or graphical elements associated with that document listing, for example a “click here,” “open,” or link icon button. The data in Region 1 can be additionally supplemented with data values obtained from other sources (e.g., enterprise databases, metadata repositories, etc.) to provide a more complete picture of the documents listed in Region 1.

A region/window for displaying the content of at least one document listed in Region 1 (“Region 2: Document Content”), the document display being initiated by a user engaging with a textual or graphical element associated. This region allows for the generation of at least one document content mark-up, such mark-up representing an element of content in a document that has been visually marked up (for example, via a different font color or font background) either by a user or by the system. This region can also be modified to display more than one document, for example by showing multiple documents side-by-side simultaneously, or allowing for navigation from one to another via a hyperlinked list or via tabs

A region/window for displaying a form that contains at least one field that can be populated with an annotation/extracted data value associated with the displayed document (“Region 3: Extraction/Annotation”), whereby that value can also be associated with at least one document content markup from the displayed document. To illustrate, FIG. 1 shows that Value 1-2-1 for Data Field/Annotation 2 as associated both with Document 1 and with Content Markup 1 from Document 1. Other types of data values can also be present, for example Value 1-1-1 for Data Field/Annotation 1, which is associated with Document 1, but does not have a corresponding content markup. Data Field/Annotation 1 and Data Field/Annotation 2 are data field/annotation identifiers, which many or may not be visible to the user in the form of a field name. A field in Region 3 may have its own field name (which is typical for data extraction fields, which usually conform to a pre-specified template) or may not have a name (which is typical of annotation fields that are user-generated). A field in Region 3 can be one of multiple types, for example: a text entry field, a multiple-choice field, a dropdown field, a combination thereof, etc. Region 2 can be shown side-by-side with Region 3, either to the right or to the left of it. In an embodiment of this invention, users can choose which region arrangement they prefer, whereby the assumption is that right-handed users would prefer Region 3 on the right and left-handed users would prefer Region 2 on the left. In another embodiment of this invention, especially where there is limited horizontal space (e.g., a mobile device in portrait orientation), Region 2 may be placed above or below Region 3.

These three regions are interlinked, such that a user (or a combination of user and system) performing an action in one region affects what content or data is displayed (or populated) in at least one other region, and the user flow builds sequentially from Region 1 to Region 3, specifically:

User Flow from Region 1 (Table of Documents Region) to Region 2 (Document Content Region 2):

A user interacting with a document identifier in Region 1 (for example, clicking on it hovering over it, etc.) loads/displays the content of that particular document in Region 2. To illustrate, in FIG. 1, interacting with the identifier for Document 1 in Region 1 loads the content for Document 1 in Region 2 (e.g., a PDF or HTML file showing the document content). This user flow has a preferred direction, from Region 1 to Region 2. The direction from Region 2 to Region 1 can also be enabled, whereby loading of a document in Region 2 makes visually salient the identifier for that document in Region 1 (for example, by changing the font for the document identifier to bold or changing the background color for the identifier)

If a user interacts with the data value for a document in Region 1, and if the data value is associated with a markup/mark-up in that document, when the document gets displayed in Region 2, it would be automatically scrolled to the page or location in the document where the markup/mark-up is located. Additionally, the corresponding data value for that markup/mark-up can be loaded, scrolled to, or otherwise visually emphasized in Region 3.

### User Flow Between Region 2 (Document Content Region) and Region 3 (Extraction/Annotation Region):

A user generates at least one content markup for a document in Region 2 and associates that document content markup with at least one corresponding annotation/data field value in Region 3, thereby establishing a linkage between the two data elements, such that any subsequent interactions with the document content markup in Region 2 causes the corresponding annotation/data field in Region 3 to increase in visual salience and/or vice versa. To illustrate, in FIG. 1, a user can generate Content Markup 1 for Document 1 in Region 3 (for example, by selecting a relevant text fragment with the cursor/mouse and then letting go of the cursor/mouse, which would create a colored markup across the selected text) and then enter or select Value 1-2-1 for Data Field/Annotation 2 in Region 3 (for example, by positioning the cursor inside the field and then typing or pasting Value 1-2-1 or by selecting Value 1-2-1 from a dropdown/multiple choice list), thereby establishing an association between the two elements. The linkage between document content markup and its corresponding annotation/data field can happen not just from Region 2 to Region 3, but also the other way around. To illustrate, in FIG. 1, a user could enter or select Value 1-2-1 for Data Field/Annotation 2 in Region 3 and then generate Content Markup 1 for Document 1 in Region 3, thereby establishing the same association between the two elements (this step may also involve, for example, the user clicking on a visual icon associated with Data Field/Annotation 2 that enables content markup-ing, and then proceeding to create Document Content Markup 1). The visual salience of a document content markup or of an annotation/data field can be automatically increased in multiple ways, for example: The system changes the visual appearance of the document content markup or annotation/data field, for example by making the relevant font bold or underlined. The system causes Region 2 (or Region 3) to scroll, or positions the cursor in Region 2 (or Region 3) to where the content markup (or data field) is located inside that region. In Region 3, if a data field is associated with a data category, and that category is configured to display or make visually salient its contents (i.e., its associated data fields and their values) only upon a particular event happening, the system causes the contents for that data field to become visible or visually salient. For example, if the data category is located inside an accordion that may be either open or closed, the system opens the accordion; if the data category is located inside a tab that may be either selected or unselected, the system selects that tab. More information on how different linkages can be created is provided in the section “Within a Document: Linkages between Document Content Region and Extraction/Annotation Region.” This linkage can be (but need not be) bidirectional. Region 2 and Region 3 may additionally track with each when scrolling, so that the content or data elements shown in one region determine what content or data elements get shown in the other region

User Flow from Region 3 (Extraction/Annotation Region) to Region 1 (Table of Documents Region):

If the value for a data field associated with a document in Region 3 is also displayed in Region 1 (in its exact form as in Region 2, or as an interpretation of the value from Region 2), then a user generating or changing that value in Region 3 leads to a corresponding value generation or change for that document in Region 1. The data value in Region 3 that gets generated or changed can, but does not need to, be associated with a corresponding Document Content Markup in Region 2. To illustrate, in FIG. 1, if a user generates or updates Value 1-1-1 (which is associated with Document 1), in Region 3, the same value (or some interpretation of it) also gets displayed in Region 1, in association with Document 1. Similarly, if a user generates or updates Value 1-2-1 (which is associated with Document 1 and with Document Content Markup 1 in Region 1) in Region 3, the same value (or some interpretation of it) also gets displayed in Region 1, in association with Document 1. The generation of or change in the data value shown in Region 1 can happen either instantaneously, or upon the user performing a particular action (for example, saving the corresponding document or refreshing the page). Additionally, the user flow can also happen from Region 1 to Regions 2 and/or 3. For example, clicking on a data value for a document in Region 1 opens that document in Region 2 (if it's not open yet), and makes salient that data value in Region 3 (for example, through font changes, region scrolling, cursor positioning, accordion opening, or tab display enabling). If the data value is associated with a corresponding document content markup in Region 2, then the location of that document content markup in Region 2 can also be made salient (for example, through font changes, region scrolling, or cursor positioning).

The three regions are interlinked, such that a user action performed in a region causes a system response (or calls for a corresponding user action) in another region, enabling a chain of actions-responses, actions-actions, or combinations thereof that has the potential to form a full loop between the three regions. To illustrate, in FIG. 1: In one case, a potential full loop involves the following: a user selects Document 1 in Region 1, which causes the content for Document 1 to load in Region 2; the user creates Document Content Markup 1 in Region 1 and associates it with Value 1-1-1 for Data Field/Annotation 1 in Region 2; the user makes a change to a value in Region 3—for example, Value 1-1-1 or Value 1-2-1—which updates that corresponding value (or its interpretation) in Region 1. For the full loop between the three regions to hold, it is not necessary that the value from Region 3 that gets displayed in Region 1 have a corresponding document content markup in Region 2, which is why both Value 1-2-1 and Value 1-1-1 in FIG. 1 are suitable for enabling the full loop. In another case, a potential full loop involves the following: a user selects Document 1 in Region 1, which causes the content for Document 1 to load in Region 2; the user clicks on the already created Document Content Markup 1 in Region 1, which automatically makes salient Value 1-1-1 for Data Field/Annotation 1 in Region 2; the user makes a change to Value 1-1-1 in Region 2, which updates Value 1-1-1 (or its interpretation) in Region 1.

The three regions are integrated, such that a change of a data element in one region causes a corresponding change to the interlinked data in at least another region, which enables a chain of events that has the potential to form a full loop between the three regions. For example, in FIG. 1, a user selecting Document 1 in Region 1 causes the content for Document 1 to load in Region 2; a user selecting the text underlying Document Content Markup 1 in Region 1 causes the selected text to become automatically populated in the field for Data Value/Annotation 2 (whereby the text shows up as Value 1-2-1); a user confirming Value 1-2-1 for Data Field/Annotation 2 in Region 2 causes the display of the Value 1-2-1 in association with Document 1 in Region 1.

The list of documents in Region 1 and the content of the document(s) loaded in Region 2 can be generated in multiple ways, for example:

The user manually or automatically uploads one or more documents to the system, or provides a list of references and/or a link to a full-text database that the system then uses to retrieve and upload the relevant documents

Documents get accessed via a cloud storage solution or other internet accessible location. In this case, the system may function as a plug-in to a cloud storage solution, to facilitate data extraction/annotation and organization within a set of documents, or within a document folder

Within a Document: Linkages between Document Content Region and Extraction/Annotation Region

A document content markup in Region 2 can be linked to an element in Region 3 in one of several ways:

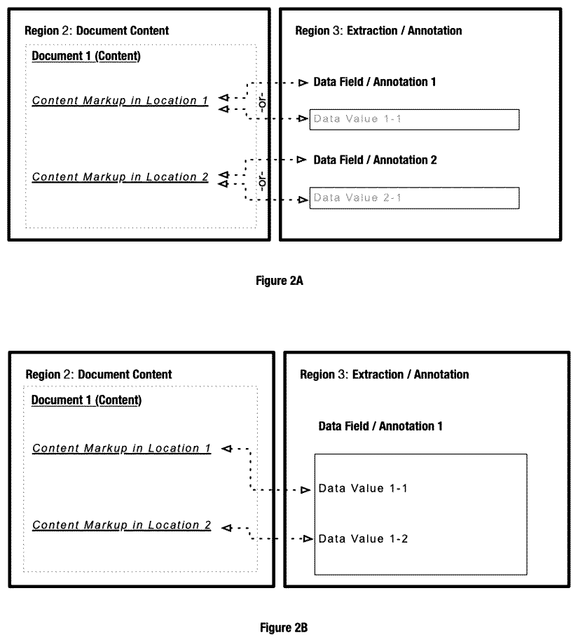

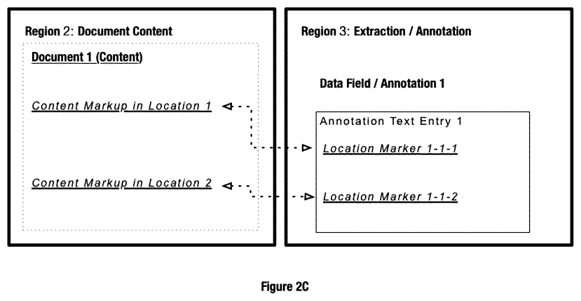

(FIG. 2A) If the data field in Region 3 allows for the entry or selection of a single value (for example, a text entry or value to be selected from a dropdown list or multiple-choice menu), then the document content markup can be linked to the entered/selected value or, alternatively, to the data field itself

(FIG. 2B) If the data field in Region 3 allows for the entry or selection of multiple values (for example, by allowing users to generate a list of values), then each value can be linked to its own document content markup

(FIG. 2C) If the data field in Region 3 is an annotation field (which entails comments or explanations), then the text entered into the annotation field can be linked to one or multiple document content markups. The linkages could be created in multiple ways, from multiple directions: for example, by starting with the annotation and adding one or more content markups, or by starting with one or more content markups and assigning it/them to the annotation. The linkages between multiple markups and one annotation can be done by generating the markups either sequentially or concurrently. For example, concurrent generation can happen by holding down a key or combination of keys. If linkages to multiple document content markups are present, then a visual indicator can get automatically created for each linked document content markup, the visual indicator serving as a symbolic location marker for that markup. The visual indicator may be shown, for example, as a schematic representation of a bookmark. The visual indicator may also display additional information about the document location where the corresponding document content markup is located, such as the document page number, document section name or number, a combination thereof, etc.

If a field in Region 3 is a text-based entry field, the manner in which it gets populated with text differs based on whether the field pertains to a data extraction or a data annotation task. For a data extraction task is it assumed that users want to record the relevant text from the document, in its exact or closely matching form. Hence, a text entry field classified in the system as pertaining to data extraction will allow users, upon selecting a relevant document text element and hence creating a document markup, to automatically copy the document text underlying the markup; the copied text then gets auto-populated into the text entry field indicated by the user, either automatically, or upon the user clicking inside that field. For a data annotation task, it is assumed that users want to generate their own comment or explanation pertaining to the relevant document text; if a comment or explanation is linked to a markup for the relevant document text in Region 2, there is little utility in also showing the relevant document text in Region 3. Hence, a text entry field classified in the system as pertaining to data annotation will allow users, upon creating a document markup, to automatically copy the document text underlying the markup; however, the copied text would get populated into the text entry field only if the user specifically enables the automatic text population.

The fields and data categories in Region 2 can be either pre-defined, defined by the user, or dynamically generated based on the type of document.

A Flexible Template System for Configuring Data Linkages

In a traditional system that employs user-defined settings or configurable templates for data extraction/annotation forms, users can typically choose, for any data extraction/annotation field, the field name and type, and perhaps specify one or more visual styling elements (colors, font, etc.). However, such templates do not enable users to choose whether and how they want markup content from Region 2 (Document Content) to be displayed in the context of any corresponding data extraction/annotation field in Region 3 (Data Extraction/Annotation).

The present invention provides users with such choice, based on the assumption that a user may prefer a certain display approach over another based on the type of task she plans to conduct (i.e., a data extraction or annotation task) and/or other task characteristics. Specifically, for a text-based entry field (in Region 3) associated with a document content markup (from Region 2), users can choose:

Whether to enable the auto-population of that field with the document text underlying the markup. If the auto-population is enabled for such a field, whether to populate the field with the entire document text or only an initial fragment (for example, by specifying a character limit for the populated text). If location markers are used for such a field, what kind of information the location marker should display (for example, document page number, document section name/number, a combination therefore, etc.)

Additionally, the system allows users to:
Select and load a predefined template, for example by choosing from a menu of available templates in Region 2
Make changes to the fields or data categories for an existing template that the user has already started using, without losing in the process data that the user has already extracted
Within a Document: Optimal Visual Display of Extracted Data for Documents Containing Descriptions of Multiple Data Units in Region 3
Sometimes, when a document describes multiple data units—for example multiple datasets or studies (in empirical research papers), multiple cases (in legal documents), etc.—the content of the document ends up having a hierarchical, nested structure that is best represented as being organized along at least two different dimensions:

A standardized dimension that is largely consistent across documents of the same type, and which may refer to:

The formal organizational structure of the document, which typically includes a succession of standard document sections. For example, a scientific research paper may contain standard sections such as Abstract, Introduction, Theory, Research Hypotheses, Methods, Results, Conclusion/General Discussion, etc.

The document data structure, which includes a collection of data fields (and may also contain data categories associated with such fields) that are typically presented in a document of that type. For example, a scientific research paper describing quantitative studies may contain data categories such as bibliographic elements, methodological details, variables, effect sizes, etc., whereby a data category such as methodological details may include fields such as sample size, average age, etc. As another example, a legal case summary may contain case-related data elements such facts, issue, holding, rationale, etc.

A non-standardized dimension that refers to the data units presented in the document, whereby each unit contains values for one or more data fields or data categories, multiple data units can occur in the same document, and the number of data units varies across documents of the same type. For example, a scientific research paper describing a quantitative research project may describe multiple studies or datasets associated with that research project, whereby each study or dataset contains information on methodological details, variables, effect sizes, etc. Similarly, a legal document may contain details about multiple legal cases.

The document sections describing each data unit and the sections pertaining to the formal document structure or data structure may be fully or partially nested within each other.

In a fully nested structure, for a document with multiple data units, the same at least one data category (or the same field within a given data category) occurs once for every data unit. For example, in an empirical research paper with multiple studies, each study will have its own value(s) for data categories such as methodological details, variables, effect sizes, etc.

In a partially nested structure, for a document with multiple data units, there is at least one data category (or at least one field within a given category) that does not occur for every data unit. For example, in an empirical research paper with multiple studies, a data category such as the bibliographic elements of the paper occurs once, for the entire document

Optimal Visual Display of Extracted Data in Region 3

To enable the efficient navigation of the data extracted from a document describing multiple data units, in a preferred embodiment, the formal document sections/data categories and the data units (i.e., studies, datasets, cases etc.) are shown in Region 3 as a combination of vertically- and horizontally-aligned navigation elements, as follows:

The document sections/data categories/data fields are vertically aligned, one under the other. Each section may be represented, for example, inside an accordion that a user can open and close.

The data units are symbolized by visual identifiers that are horizontally aligned, and which are configured such that that a user (or system) interacting with a visual identifier for a particular data unit loads the data value(s) pertaining to that information unit into the relevant location in the Data Extraction/Annotation (Region 3)

A user may interact with the visual identifier for a data unit in multiple ways, for example by clicking on or hovering over the identifier. The relevant location into which the data value(s) for a data unit get(s) loaded may depend on the type of data value getting loaded, such that:

If the data value is a single element (i.e., a text string, multiple-choice selection, etc.), then the data value may be loaded into the field in which it was originally extracted.

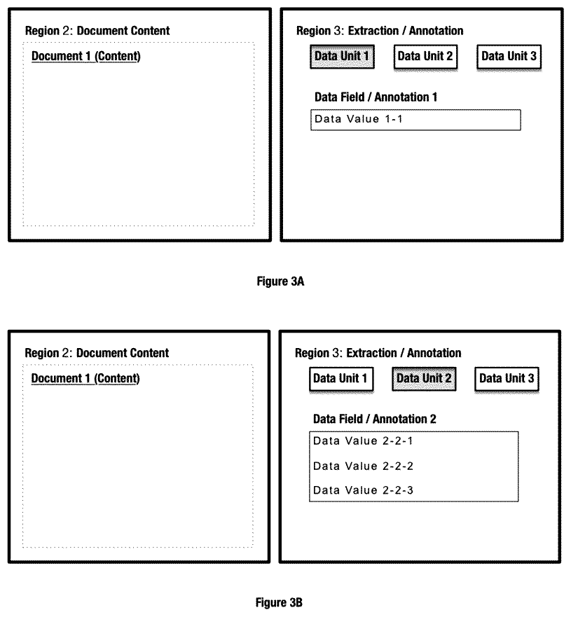

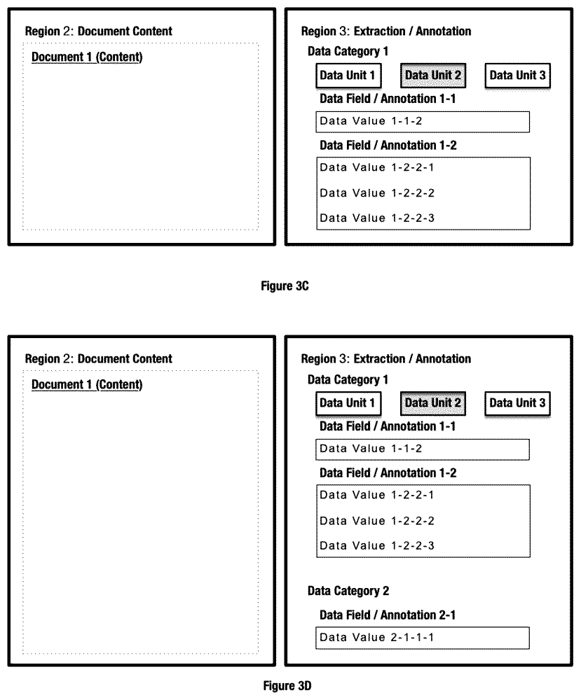

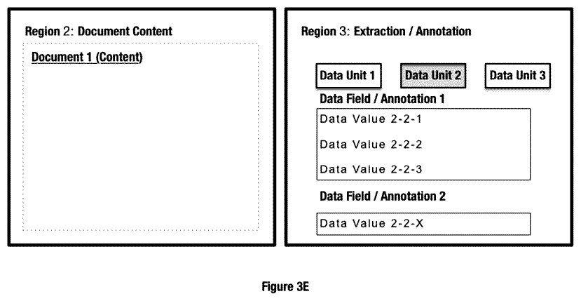

If the data value is a list of elements, then this list may be loaded into a dedicated section that is separate from the field in which each value from the list was originally generated. For example, such a dedicated section may be located above or below the corresponding data extraction field for that value. The separation between the data extraction field and the list of values generated from using that data extraction field allows users to engage in the process of adding new values to the list while simultaneously being able to keep track of the already extracted values on the list (see illustration in FIG. 3E)

To enable this visual display format, the system must be configured to generate, for each value extracted from a document, an identifier that indicates, at a minimum, what data extraction/annotation field and data unit that value is associated with. If multiple data fields are grouped into data categories, the system additionally needs to associate each such data field with its corresponding data category.

The explicit association between a data field and its corresponding data category may or may not be reflected in the identifier for a value extracted from a document

The identifier for a value extracted from a document is typically not visible to the user, although parts of it may be visible in certain cases, for example to help identify different values in a list of values.

This visual display format provides the benefit of enabling users to:
read a large volume of extracted data without having to scroll too far down Region 3
easily compare the values for the same data extraction/annotation fields across multiple data units, which is particularly useful for documents with a large number of studies/datasets/cases.

In an alternative embodiment, the data units may be vertically aligned, for example inside accordions stacked underneath each other. However, such a display does not seem optimal because:

Given the variation in the number of data units across documents of the same type, one cannot predict how many vertical sections may have to be displayed in Region 3 to account for all the data units in a document. For documents with a large number of data units, users may end up needing to scroll very far down in Region 3 to see the relevant data.

The vertical alignment does not allow users to easily compare the values for the same data extraction/annotation fields across multiple data units.

FIGS. 3A-E, which are exemplary rather than exhaustive, show the optimal visual display for a document with a nested data structure, with different levels of data complexity.

FIG. 3A shows an Extraction/Annotation Region with a single text entry field (Data Field/Annotation 1), which is not associated with any data category, and which accepts a single value as text input, whereby this value may differ based on the Data Unit it is associated with. Data Value 1-1 has been extracted/generated from the document, indicating that it refers to Data Field/Annotation 1 and Data Unit 1.

FIG. 3B shows an Extraction/Annotation Region with a single text entry field (Data Field/Annotation 2), which is not associated with any data category, and which accepts a list (i.e., array) of values as text input, whereby the list of values may differ based on the Data Unit it is associated with. The list of Data Values 2-2-1 to 2-2-3 has been extracted/generated from the document, indicating that it refers to Data Field/Annotation 2 and Data Unit 2, with each individual value in the list having a unique identifier.

FIG. 3C shows an Extraction/Annotation Region with two text entry fields (Data Field/Annotation 1-1 and Data Field/Annotation 1-2), which are both associated with Data Category 1, and which accept as input a single value and a list (i.e., array) of values, respectively, whereby both the single value and the list of values may differ based on the Data Unit they are associated with. The Data Value 1-1-2 and the list of Data Values 1-2-2-1 to 1-2-2-3 have been extracted/generated from the document, whereby their identifier structures are similar to those in FIG. 3B, with the addition of a category identifier. The category identifier, however, is not necessary to be included here if another identifier exists that specifically associates Data Values 1-2-2-1 to 1-2-2-3 with Data Category 1.

FIG. 3D shows an Extraction/Annotation Region with three text entry fields (Data Field/Annotation 1-1, Data Field/Annotation 1-2, and Data Field/Annotation 2-1). Data Field/Annotation 1-1 and Data Field/Annotation 1-2 are associated with Data Category 1, and their values may differ based on the Data Unit they are associated with. Data Field/Annotation 2-1 is associated with Data Category 2, and its value is independent of Data Units.

FIG. 3E is similar to FIG. 3B, but additionally shows the list of generated values for Data Field/Annotation 2 being located in its own, dedicated section. This allows users to continue using Data Field/Annotation 2 for adding new values to the existing list of values (as represented by Data Value 2-2-x).

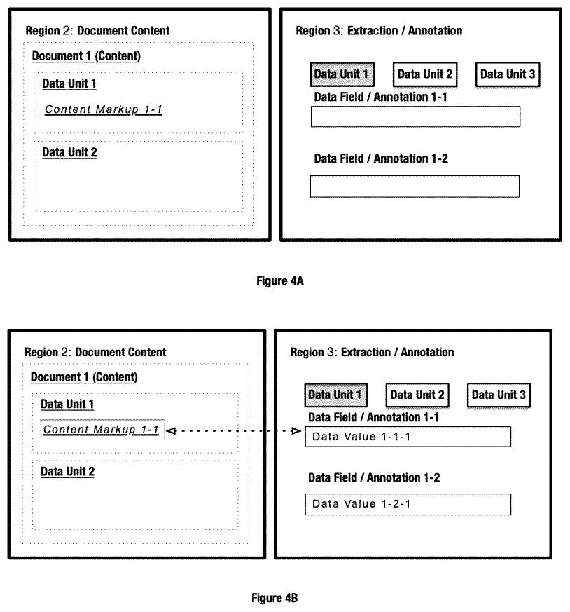

Interactivity and Interlinking Between Region 2 and Region 3 Elements (FIGS. 4A-B)

The document content markups in Region 2 and their corresponding data values/annotations in

Region 3 represent elements that are interactive and interlinked, to facilitate convenient (a) data classification/export and (b) data tracking and review. Specifically:

For data tracking/review:

Interacting with an element from a region (i.e., either a document content markup in Region 2 or a linked data value in Region 3) causes its corresponding, linked element from the other region to become more visually salient.

The interaction with an element can take on multiple forms, for example the user clicking on or hovering over that element, or the system automatically selecting or enabling that element

The visual salience of an element can be increased via multiple approaches, for example:

If the element is a document content markup in Region 2, its visual salience can be increased by the system triggering, among other embodiments, on or more of the following: the document content in Region 2 to scroll to the location where the content markup is located; the cursor to become positioned at or next to the location where the content markup is located; the visual appearance of the document content markup to change, for example through a change in background color or font styling; change bars in the margins of Region 2 can also be configured to be shown, also indicating metadata such as the annotator and date/time modified; metadata can be represented by the color, thickness, style or location of the change bar or by aligned text, or by hovering over the marked-up annotation or change bar, as with a tooltip

If the element is a linked data value/annotation in Region 3, its visual salience can be increased via:

The system causing that element to stand out, for example by triggering, among other embodiments, on or more of the following: the content in Region 3 to scroll to the location where the linked data value/annotation is located; the cursor to become positioned at or next to the location where the linked data value/annotation is located; the visual appearance of the linked data value/annotation or the location marker(s) associated with an annotation to change, for example through a change in background color or font styling

The system causing the Region 2 section associated with that element to stand out, for example by triggering, among other embodiments, on or more of the following: the corresponding accordion for that data value/annotation to open (for data values/annotations located inside an accordion that may be opened or closed); the corresponding data unit associated with that data value/annotation to become active and load some or all the data values/annotations assigned to that data unit (for data values/annotations associated with a particular data unit, which may be loaded only when that data unit is activated); the system determines which data unit to activate in Region 3 by inferring, from the position or from the identifier of the corresponding content markup in Region 2, which data unit that content markup is associated with as shown in FIG. 4A.

The different approaches for increasing the visual salience of an element, or the different implementations of such approaches, can also combined. For example, in FIG. 4B, when a user interacts with Content Markup 1-1, which is located inside Data Unit 1 in Region 1, all the extracted values for Data Unit 1 load into the data extraction/annotation fields in Region 3. Additionally, among the loaded values, Data Value 1-1-1—which is linked to Content Markup 1-1—becomes visually salient.

This interlinking feature between elements in Regions 2 and 3 makes it easy for users to track the extracted data/annotations and check them for accuracy, since the data available in Region 3 can be easily traced back to its underlying supporting content in Region 3, and any content markup in Region 2 can be easily inspected for classification accuracy in Region 3.

Elements from Regions 2 and 3 can additionally be interlinked so that deleting (or editing, where relevant) an element in a region causes its corresponding, linked element from the other region to automatically get deleted (or edited, where relevant), too.

This interlinking feature between elements in Regions 2 and 3 keeps the annotation process streamlined for the user, by preventing users from having to retrieve and delete/edit elements from each region individually.

Each element in Region 2 (i.e., document content markup) and each element in Region 3 (i.e., data field/annotation, data value, location marker, data unit, data category) gets assigned a unique and persistent ID, and so do any linkages between elements from Regions 2 and 3, so that they can be referenced by the system at any point in the future.

The persistent IDs can be used, for example, for representing the data extracted from a document in RDF format (Web 3.0)

For Data Classification/Export

Data values/annotations may be assigned to data categories and potentially even sub-categories (e.g., strengths/weaknesses, major/minor points). Data values/annotations may additionally be associated with one or more visual indicators (i.e., document content markups in Region 2 and/or location markers in Region 3). Such document content markups and/or location markers may visually differ based on the data category/sub-category their corresponding data value/annotation is assigned to. If a user chooses to re-assign a data value/annotation from one category or sub-category to another (for example, by dragging the data value/annotation to a different category), and if the initial and target category or sub-category have different visual indicators, then the appearance of the relevant location markers in Region 3 and/or content markups in Region 2 changes accordingly. This feature makes it convenient for users to correct an extracted data value/annotation, since they need to perform a single corrective action, which automatically corrects all the visual indicators linked to that data value/annotation.

When the data extracted/annotated from a document or document section gets exported (to a text document, spreadsheet, or some other kind of document format), and such data is associated with at least one location marker in Region 3, then the data contained in the location marker may also get exported and appended to its corresponding data value/annotation.

For example, if a location marker for a data value/annotation in Region 3 contains the page number(s) and/or names of the sections associated with that data value/annotation in Region 2, the exported output would show the data value/annotation followed by the corresponding page number(s) and/or section name(s) in brackets.

The appending of the location marker information in the exported file may happen either automatically or when the user opts for it.

This feature removes from the user the burden of having to manually identify and record each document location pertaining to specific comments, notes, or extracted values

Automatic Assignment of Extracted Data/Annotations to Their Corresponding Data Category/Data Unit

The invention includes a method for creating and automatically classifying and displaying evidence-linked data values/annotations, which entails the following steps:

The system identifies one or more sections in a document

This can be done through various methods, e.g., importing/reading section bookmarks from the document, using rules/NLP/AI, or having a user identify the sections manually

The sections can refer, for example, to the formal organizational structure of the document (e.g., Abstract, Introduction, Theory, Research Hypotheses, etc.), to the data units described in the document (e.g., studies, datasets, legal cases, etc.), to a combination of both, or to some other type of section or combination of sections

When a user engages with a section of that document in Region 2 (for example, positions the cursor inside that section, or selects a document content element for tagging inside that section, whereby the document content element can be, for example, a text fragment or a graphic element), the system identifies that particular document section and automatically opens or activates the corresponding section in Region 3 (this works both for text selection or cursor positioning), whereby:

The opening vs. activation depends on the type of section:
if the corresponding section is an accordion for a data category, the accordion gets opened
if the corresponding section is an indicator for a data unit, the indicator for that data unit gets ‘activated’ (for example, it gets shown in a different font or background color), and the data values associated with that data unit may additionally get loaded

An additional step may also be automatically performed, especially for data extraction (as opposed to annotation) tasks:

If a document has multiple data units, and the user specifies (either directly or indirectly) which data extraction field the marked-up content element should be associated with, then the system automatically displays the extracted data under the corresponding data unit and creates an internal linkage to that data unit.

For example, if the user selects, in Region 2, a text located inside Study 1 in a document (thereby creating a content markup), and then positions the cursor inside the Study Design field in Region 3 (thereby indicating that the marked-up content represents the supporting text for the Study Design field), the system automatically pastes the marked-up text into the Study Design field and creates an internal linkage to Study 1, such that a user engaging with the content markup in the future automatically ‘activates’ Study 1 and displays the data value associated with that markup in the Study Design field.

If the specified data extraction/annotation field has more than one value per data unit, the system automatically adds the new value to a running list of values for that particular data extraction/annotation field, and links this new value both to its corresponding data unit and to its corresponding content element markup in Region 2.

The same approach holds if the specification as to what category the marked-up content element belongs to is made not by a user but by a machine-based algorithm.

Automatic List-Building with Extracted Data

If a data field/annotation allows for the extraction of a list of values, then each new value added to the list automatically receives an ID that contains information about the number of already extracted values for that particular data field, either across the entire document or within the information unit associated with that data field value (if the document contains multiple information units).

This automatically generated ID determines the position of the newly added value inside the list, and parts of it may even be visible to the user (to help the user more easily track the number of items in a list and the identity of each list item). The new list value is then connected to its corresponding content markup in Region 2, if available, and to the corresponding data unit.

For example, a user is extracting data from an empirical research paper and markups, in Region 2, a text element located inside Study 1, and then specifies in Region 3 that the text element is a value for the “Independent Variable” (IV) field. If the IV field has a list format and already has two other values extracted (IV1 and IV2), the system would automatically create the identifier “IV3” for the newly added list value, would list it below IV2, and link it to its corresponding content markup in Region 2 and to Study 1.

For data values that have an inherently hierarchical structure to them, the automatically generated ID may be composed of several elements, whereby at least one element has a dependency with the element before it. In that case, the generation of the ID may contain a combination of user-selected and automatically-generated values.

The system can be configured to utilize a single ID generation field to create such an ID, via a combination of sub-fields with drop-down menus, whereby the user selects the value(s) for some of the fields, and the system automatically generates the value(s) for the others.

For example, a user may want to indicate that a data value from a medical research paper represents the treatment (versus control) group for a particular independent variable. For example, the user may specify, in the first drop-down sub-field, that the data value pertains to an Independent Variable (IV; as opposed to a Dependent Variable, Mediator Variable, etc.). As a result, because two other IV values have already been extracted from that document or data unit, the system automatically generates the value “3” for the IV. Next, the user specifies that the data element represents a Group (GR; as opposed to a measure or manipulation) for that Independent Variable. As a result, because no groups have been defined for that Independent Variable yet, the system automatically generates the value “1” (or some other value, like “T” for “treatment”) for that Group.

Users can also choose the order of the variables, by moving them up/down in the list or manually setting the ID number, in both cases the system re-generates all numbers following the change

For example, a user moves IV4 above IV2 (or renames it IV2) then the former IV2 gets regenerated as IV3, and subsequent variables get recoded as appropriate, before resorting the list

If the list-building involves the concurrent extraction of multiple list values, the system can be configured to perform the following steps:

The user selects the list of values to be extracted from the document in Region 2. Such list can represent, for example, a bullet point list in a text, or the content of a table column. This step can be performed, for example, by marking up with the mouse the content to be extracted from the document or using the mouse to draw a rectangle around the content to be extracted.

If a list contains multiple levels, users can indicate the level at which they want to extract the data. For example, they can choose to ignore all text with a certain indentation or font style, as such text is likely to represent a category heading rather than a relevant data value.

The system uses a table data extraction method to identify, read, and convert the selected content into a data vector, like a table column. This step can be performed, for example, via a data extraction application

The text from each row in the generated table column gets extracted and converted into a list of values

In cases in which a document contains multiple data fields that accept lists of values, determining the correct field to which to assign the extracted list is done in two ways:

The user specifies, at any point before this step, the correct field (for example, by clicking a button for a particular field, or selecting the relevant field value from a drop-down menu)

The system automatically determines the correct field based on the position of the list within the document (for example, if the list is positioned in the References section, the system may infer that it represents a reference)

Each list value receives an automatically generated ID, with the sequence of IDs increasing from the first row to the last

The list of values (and potentially also their automatically generated IDs) gets displayed to the user, for review. If needed, the user can make corrections or other changes to any individual list value or its ID, including:

Deleting a value, merging values, editing the ID of a value, or editing the text of a value

If an ID is changed or a list value is deleted or merged, all IDs underneath are automatically updated to reflect the change

### Upon User Confirmation:

The user-reviewed list of values with their respective IDs gets displayed inside the section in Region 3 that had been configured by the system as the display area for such a list of values

If the document contains multiple data units, and the list content in Region 2 is associated with a particular data unit, then each extracted list value gets automatically assigned to that data unit

Each value in the list gets linked to its corresponding markup in the document. Additionally, if the section in Region 3 in which the newly extracted list is located is an accordion, the accordion gets automatically opened, so the user can see the newly extracted list inside it.

Additionally, if the list is associated with a particular data unit, the visual indicator for that data unit gets ‘activated’ in the section in Region 3 in which the newly extracted list is located

### Extension & Re-Use of Document Data Extractions/Annotations

The system can be configured to accept additional levels of data nesting, for example per project, team, etc.

The system can be configured to allow multiple users to collaborate on the same data extraction/annotation project

As a result, the ID for each extracted data value/annotation would contain identifiers for the user who generated it and/or the project or team it is associated with.

The system can also allow for multiple users to post comments or engage in online conversations in real time, whereby the content of the comments/online conversations would be displayed in Region 2, and linked to any corresponding document content markups in Region 2.

The system can be configured to allow for the reuse of documents with linked content markups and data values/annotations, whereby the reuse would be enabled across projects, within or across organizations. Such reuse would enable the creation of:
a database of annotated documents searchable by different members within an organization
a repository for Machine Learning training data
a marketplace of annotated documents

The system can be configured to associate the various data artifacts to knowledge representation systems.

Data artifacts such as data fields, data values, annotations, data units, document metadata, author metadata, etc. can be linked to internal and/or external knowledge representation systems.

Knowledge representation systems include dictionaries, taxonomies, thesauri, Knowledge Organization Systems, formal ontologies, or any other such system that provides a mechanism for linking data. Knowledge representation based on the subject, predicate, object model (as in RDF—Resource Description Framework) are such systems.

Data artifacts linked to knowledge systems create interconnectedness (linkage) of data artifacts not only within a document, but across all documents. Such linkage:

Enables the application of human context on the clustering and classification process

Empowers inference (the ability to apply processes to conceptually similar artifacts and discover new relationships that are not explicitly defined)

Empowers semantic search, the ability to extract meaning and intent from a request and via inference to find the most relevant information

Increases the capacity for analytics and machine learning that leverage such relationships

Simplifies the translation of concepts across human languages

Invention pertaining to the written report/review document generation process

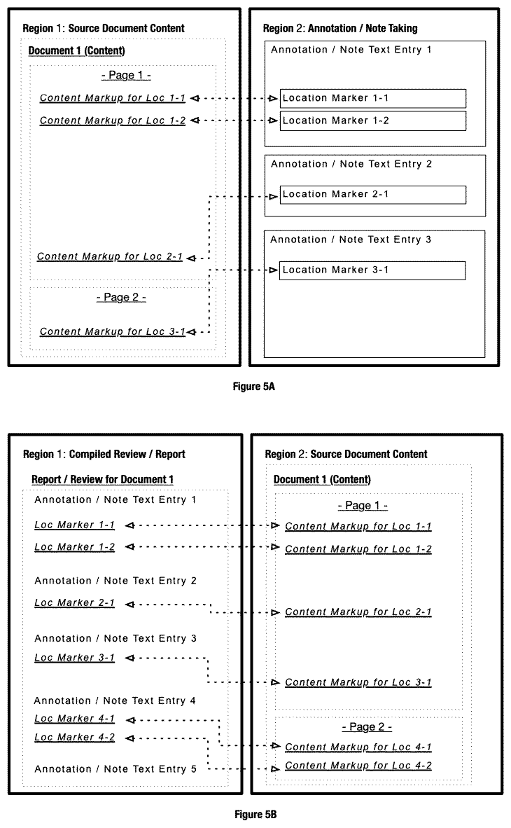

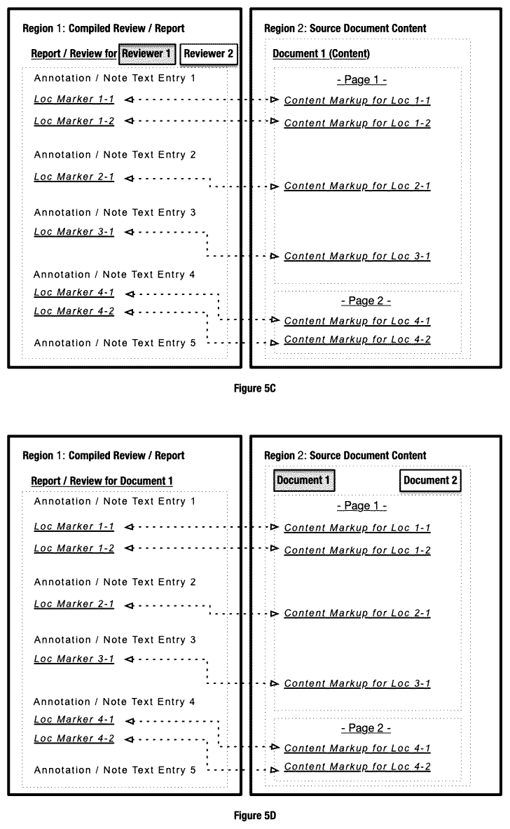

The Invention pertaining to the written report/review document generation process the contains the following central elements, described in FIGS. 5A-D: (a) a source document, (b) an area for creating annotations/notes pertaining to (and correspondingly linked) to the source document, containing corresponding location markers, and (c) a review/report produced from compiling the existing annotations/notes, linked to the source document, containing corresponding location markers, and available to users for further editing.

The three main elements are displayed in pairs of two (source document+annotations/notes and review/report+source document) within two regions shown side-by-side. The pair or elements that gets shown depends on the task that the user is performing (annotation/note-taking vs. review/report reading and editing), such that the user experiences the system as providing two views: an Annotation/Note-Taking View (for annotation/note-taking) and a Review/Report View (for review/report reading and editing).

(Optional) In each view, one region is automatically designated as the main region (Region 1), and the other as the supporting region (Region 2), to make it as easy as possible for the user to perform the task associated with that view. In the Annotation/Note-Taking View, the user needs to be able to easily read and interact with the source document; hence, the source document would be shown in Region 1. In the Review/Report View, the user needs to be able to easily review and edit the compiled review/report; hence, the review/report document would be shown in Region 1. Therefore, when users switch from one view to another, the content shown in Region 1 will switch from one type of document to another.

There are different visual features that can be used for making a region the main region (for example, locating the region in a central position, or making the region larger in size than the supporting region). At a minimum, the main and supporting region should be designed in such a way that the supporting region is never provided more visual focus than the main region (i.e., the supporting region should not be larger than the main region).

The two views, along with additional, non-central elements of the system are described in more details below:

Annotation/Note-Taking View (FIG. 5A). Users create annotations/notes (in Region 2: Annotation/Note-Taking) pertaining to a source document (shown in Region 1: Source Document Content), whereby the source document in Region 1 and the annotations/notes in Region 2 are shown side-by-side.

If an annotation/note relates to a particular location in the source document, a linkage is automatically created between that annotation/note and the relevant location in the source document. Each linkage involves the creation of one or more content markups in Region 1 and its/their corresponding location marker(s) in Region 2 (e.g., page numbers and/or sections numbers/names), which are connected via hyperlinks.

Detailed descriptions of the possible creation of linkages between the two regions (including the correspondence between content markups in the region displaying the source document content and location markers in the region displaying the annotations/notes) are presented in Appendix A.

(optional) Region 2 can be structured either as a collection of one or more annotation/comment boxes or as an extraction template.

The location of Region 1 and Region 2 may be as shown in FIG. 5A, with Region 2 on the right-hand side and Region 1 on the left-hand side. Region 2 may alternatively be shown on the left-hand side, to better fit the needs of left-handed users. The position of the two regions vis-à-vis each other can be either fixed or determined by users themselves based on their needs and preferences.

### Review/Report View (FIG. 5B).

All the annotations/notes (or, alternatively, the annotations/notes selected by a user) get compiled into a report/review document (such as a text- or HTML-based document), shown side-by-side with the source document.

If the annotations/notes contain one or more linkages to the source document, those linkages get preserved and automatically converted to linkages between the report/review document and the source document. Each linkage involves connecting, via hyperlinks, one or more content markup(s) from the source document with its/their corresponding location marker(s) in the review/report document.

While the content markups contained in the source document can be displayed in the same or similar way across the Annotation/Note-Taking View and the Review/Report View, the location markers may be displayed differently between the two views. In the Annotation/Note-Taking View, the location markers may need to be rather visible, to enable an efficient navigation between annotations/notes and the corresponding document content; hence, they may be shown in a visual area that is separate from the text of the annotation/note text, or may have a visual styling that contrasts with the annotation/note text. In contrast, in the Review/Report View, visually prominent location markers could detract from the experience of reading and/or editing the review/report, and would be inconsistent with the way location markers are typically expressed in a formal review/report. Instead, location markers would be shown integrated into the annotation/note text that they are relevant to. For example, the system can automatically display in brackets all relevant location information (e.g., page numbers and/or sections numbers/names) at the end of an annotation/note (whereby such an annotation/note can be a bullet point, sentence, paragraph, or collection of paragraphs), with hyperlinks between each location reference and its corresponding content markup in the source document.

The two regions don't have to be flipped in the two views

(Optional) The system can also automatically generate hyperlinked location references in the Review/Report View, in the absence of the user having created such linkages. For example, if an annotation/note mentions the name of a specific section in the source document (e.g., Abstract, Study 1, General Discussion), the system can automatically create a hyperlink between the text mentioning that section and the heading or beginning of that section in the source document. Additionally, if an annotation/note contains a quote from the source document text, but without a corresponding location marker, the system can automatically generate a location reference adjacent to the quoted text.

(Optional) If in the Annotation/Extraction Region the annotations/notes are organized into sections, and at least one section has a particular identifier (such as a digit or a heading), then in the Review/Report Document the section identifier(s) get(s) automatically shown, with the corresponding annotation(s) displayed underneath each relevant identifier(s).

In FIG. 5B, the report/review document is shown in Region 1, and the source document is shown in Region 2, as Region 1 has the role of the main region. Alternatively, the report/review document may be shown in Region 2, and the source document may be shown in Region 1.

A visual feature for accessing the Review/Report View from the Annotation/Note-Taking View.

(Optional) A second, optional feature may also be provided, for accessing the Annotation/Note-Taking View from the Review View, so that users can toggle back-and-forth between the two views.

(Optional) Compiled Multiple-Review/Report View (for multiple annotators/reviewers and/or multiple documents)

(FIG. 5C) If multiple users annotate/review a single document, the annotations/notes from each user can be shown in one view. They can be shown as one combined document (e.g., with the annotations/notes displayed side-by-side or one after the other), or can be loaded individually, when one selects a specific annotator/reviewer.

(FIG. 5D) If one or more users annotate/review multiple documents, the annotations/notes for each document can be shown in one view. They can be shown as one combined document (e.g., with the annotations/notes displayed side-by-side or one after the other), or can be loaded individually, when one selects a specific document.

(Optional) For a Multiple Review/Report View, the system can also allow for the role of a super-user, who can access the Multiple Review/Report View, and edit it into a composite report (an example of such a super-user is the Editor or Associate Editor of a peer-reviewed journal, who would have access to the review reports created by individual reviewers for a submitted manuscript, and would want to compile them into a report to be shared with the manuscript author(s)). The system can contain several features that make it easy for the super-user to create a composite report, including the following:

The individual annotations/notes can be draggable, from Region 1 to Region 2 and/or within Region 1. This will help the super-user group related annotations/notes together or organize the content of the composite report in some other way.

Each annotation/note will retain information about its provenance (i.e., which user/reviewer it was associated with), and that information can be visually conveyed when the annotation/note gets dragged from one document to another. For example, each annotation/note can be color-coded or associated with a text identifier to symbolize its provenance (i.e., the beginning of each annotation/note can indicate, in brackets, the name of its associated user/reviewer, e.g., R1).

Each annotation/note can also retain information about its order in the review/report document it came from. That way, if one or more annotations/notes get dragged out of position in a document, the super-user can click on a button that restores (or at least displays) the original order of the annotations/notes within that document.

Annotations/notes that the super-user has already interacted with (for example, by dragging or editing them) can automatically be rendered in a visual style different from the remaining annotations/notes (for example, through a different font color or font weight); this will help the super-user more easily keep track of which. annotations/notes she has already dealt with, and which ones still need her attention.

The system can incorporate an intelligent component that automatically compares and pre-groups annotations/notes together. For example, if annotations/notes from two or more users refer to the same (or similar) location(s) in a document, or are found, via an automated linguistic analysis, to reference the same or similar entities from the original document, the system can use that information to determine that those annotations/notes should be grouped together into the same category. It would then establish a correspondence between those annotations/notes. Such correspondence can be visually represented in different ways: for example, the annotations/notes can all be shown in the same stylistic manner (e.g., same font color), or the annotations/notes can be hyperlinked, so that clicking on one annotation/comment “activates” the remaining corresponding annotations/notes, by marking up them or positioning the cursor over them.

The pre-grouping together can also be accompanied by a feature that synthesizes consensus versus conflict. Specifically, an automated linguistic analysis of the annotations/notes grouped together can determine the degree of overlap in sentiment (or some other evaluative assessment) between the corresponding annotations/notes, and visually indicate whether the different annotations/notes are in consensus or conflict with one another. This visual indication can be done, for example, by showing concurring annotations/notes in the same color, and conflicting annotations/notes in different colors.

(Optional) An Export function, which takes the content of the review/report and converts it into a text- or HTML-based document (e.g., Word, PDF, HTML), so that it can be shared with others.

1. A computer-implemented, annotation-based document management system for a set of one or more documents, the system including at least three interrelated regions of a graphical user interface, comprising:
a first region of the graphical user interface that lists at least one first document, and shows, for that first document, at least two associated elements that include at least one identifier for that first document and at least one direct or indirect reference to at least one first data value associated with that first document;
a second region of the graphical user interface that can display some or all of the content of the first document listed in the first region of the graphical user interface, whereby at least one element included in the content of the first document can be augmented with at least one first visual mark-up; and
a third region of a graphical user interface that contains at least one first field that can be populated with at least one first data value associated with the first document displayed in the second region of the graphical user interface, whereby a direct or indirect reference to the first data value can be shown in the first region of the graphical user interface, as part of the at least two elements associated with the first document listed.
